(19) United States
(12) Patent Application Publication
(10) Pub. No.: US 2020/0245206 A1
(43) Pub. Date: Jul. 30, 2020

(54) BIT INDEXED EXPLICIT REPLICATION BASED MULTICAST FOR LOCATOR IDENTIFIER SEPARATION PROTOCOL

(71) Applicant: Telefonaktiebolaget LM Ericsson (publ), Stockholm (SE)

(72) Inventor: David Ian ALLAN, San Jose, CA (US)

(21) Appl. No.: 16/489,692

(22) PCT Filed: Mar. 6, 2017
(86) PCT No.: PCT/IB2017/051305

§ 371 Date: Aug. 28, 2019

(51) Int. Cl. H04W 36/02; H04W 36/00; H04L 12/18; H04L 12/761; H04L 29/06

(52) U.S. Cl. CPC H04W 36/026; H04W 36/0007; H04L 69/22; H04L 12/185; H04L 45/16; H04L 12/189

(57) ABSTRACT

A network device functioning as an ingress tunnel router facilitates multicast traffic forwarding and mobility in a network with mobile devices by receiving data traffic to broadcast to a multicast group, querying a locator identifier separation protocol (LISP) mapping system to get a list of routing locators (RLOCS) for members of the multicast group, constructing a bit indexed explicit replication (BIER) bitmap of the RLOC, and forwarding data traffic for the multicast group using the BIER bitmap. Whereas a network device functioning as an egress tunnel router supports handover processes by receiving a join for a multicast group from a subscriber node, registering interest in the multicast group with the LISP mapping system, receiving data traffic using a BIER bitmap identifying the egress tunnel router, and forwarding the multicast group data traffic to the subscriber node.

### TECHNICAL FIELD

Embodiments of the invention relate to the field of network communications; and more specifically, to the implementation of network based multicast using bit indexed explicit replication to provide efficient multicast support for the locator identifier separation protocol based networking.

### BACKGROUND

Traditional multicast distribution of Internet Protocol (IP) packets are supported via IP multicast routing and forwarding, using protocols such as Protocol Independent Multicast (PIM) or Multicast Label Distribution Protocol (MLDP) to create multicast replication state on the nodes along a multicast distribution tree (MDT) in the network. Packets flowing through the network will be replicated to the proper set of neighbors according to the multicast replication state stored at each node. The multicast forwarding states are difficult to aggregate since each multicast distribution tree may have a different set of participants. This can cause an explosion of multicast state in the core of the network where most multicast traffic passes through.

Bit Index Explicit Replication (BIER) is a multicast technique whereby the set of multicast destination nodes for a packet is encoded in a bitmap carried in a packet header of multicast packets. Since the set of destination nodes are encoded in the packet header, this eliminates the multicast state that needs to be stored at network nodes; the packet self identifies the multicast forwarding that applies for each node it traverses in the network. After determining the next hop based on the BIER bitmap, a given node uses a unicast forwarding solution to determine the set of outgoing interfaces for the packet. When a node receives a packet, it will determine the set of outgoing interfaces it needs to replicate the packet onto via comparing the set of destinations in the BIER header with the current unicast forwarding solution. When a node forwards a BIER packet through a chosen outgoing interface, the node prunes the bits in the BIER bitmap of the copy of the packet sent on that interface to eliminate the bits representing the destination nodes that are not on the shortest path associated with the chosen outgoing interface. This ensures that duplicate delivery of the multicast packet does not occur and ensures that transient loops do not cause an exponential increase in bandwidth consumption.

In a network environment that supports mobility, there can be significant churn in the updating of the multicast state when a node subscribing to one or more multicast groups moves been attachment points. Such a mobility event can trigger significant signaling in the network to update multicast state. An example of such a network environment supporting mobility is a cellular network where a user equipment (UE) (e.g., a cellular phone) may travel and connect with different towers in a radio access network (RAN) while requiring continuity of communication. Such a transfer between towers or access points is referred to as a handover process.

### SUMMARY

In one embodiment, a method is implemented by a network device functioning as an ingress tunnel router to facilitate multicast traffic forwarding and mobility in a network with mobile devices. The method includes receiving data traffic to broadcast to a multicast group, querying a locator identifier separation protocol (LISP) mapping system to get a list of routing locators (RLOCS) for members of the multicast group, constructing a bit indexed explicit replication (BIER) bitmap of the RLOCs, and forwarding data traffic for the multicast group using the BIER bitmap.

The embodiments also include a method implemented by a network device functioning as an egress tunnel router to facilitate multicast traffic forwarding and mobility in a network with mobile devices. This method includes, receiving a join for a multicast group from a subscriber node, registering interest in the multicast group with the LISP mapping system, receiving data traffic using a BIER bitmap identifying the egress tunnel router, and forwarding the multicast group data traffic to the subscriber node.

Further embodiments include a network device that functions as an ingress tunnel router to execute a method to facilitate multicast traffic forwarding and mobility in a network with mobile devices. The network device comprises a non-transitory computer readable medium having stored therein a multicast mobility manager, and a processor coupled to the non-transitory computer readable medium. The processor executes the multicast mobility manager. The multicast mobility manager receives data traffic to broadcast to a multicast group, queries a LISP mapping system to get a list of RLOCS for members of the multicast group, constructs a BIER bitmap of the RLOCs, and forwards data traffic for the multicast group using the BIER bitmap.

The embodiments include a network device that functions as an egress tunnel router to execute a method to facilitate multicast traffic forwarding and mobility in a network with mobile devices. The network device comprises a non-transitory computer readable medium having stored therein a multicast mobility manager, and a processor coupled to the non-transitory computer readable medium. The processor executes the multicast mobility manager. The multicast mobility manager receives a join for a multicast group from a subscriber node, registers interest in the multicast group with the LISP mapping system, receives data traffic using a BIER bitmap identifying the egress tunnel router, and forwards the multicast group data traffic to the subscriber node.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of the encoding of a bit indexed explicit replication (BIER) bitmap for forwarding multicast traffic.

FIG. 2 is a diagram of one embodiment of shortest path forwarding in a network implementing BIER.

FIG. 3 is a diagram of one embodiment of a cellular network implementing locator identifier separation protocol (LISP).

FIG. 4 is a flowchart of one embodiment of a process for a multicast ingress tunnel router (MITR) to forward multicast traffic to a multicast group.

FIG. 5 is a flowchart of one embodiment of a process for a multicast egress tunnel router (METR) to receive multicast traffic for a multicast group.

FIG. 6 is a flowchart of one embodiment of a process for a source tunnel router (TR) in a multicast handover process.

FIG. 7 is a flowchart of one embodiment of a process for a target TR in a multicast handover process.

FIG. 8 is a timing diagram of one embodiment of a handover call flow where both the source TR and target TR are members of a multicast group.

FIG. 9 is a timing diagram of one embodiment of a handover call flow where the target TR is not a member of the multicast group.

FIG. 10A illustrates connectivity between network devices (NDs) within an exemplary network, as well as three exemplary implementations of the NDs, according to some embodiments of the invention.

FIG. 10B illustrates an exemplary way to implement a special-purpose network device according to some embodiments of the invention.

FIG. 10C illustrates various exemplary ways in which virtual network elements (VNEs) may be coupled according to some embodiments of the invention.

FIG. 10D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 10E illustrates the simple case of where each of the NDs implements a single NE, but a centralized control plane has abstracted multiple of the NEs in different NDs into (to represent) a single NE in one of the virtual network(s), according to some embodiments of the invention.

FIG. 10F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 11 illustrates a general purpose control plane device with centralized control plane (CCP) software, according to some embodiments of the invention.

### DETAILED DESCRIPTION

The following description describes methods and apparatus to optimize forwarding decisions in a network that implements Bit Index Explicit Replication (BIER) and locator identifier separation protocol (LISP). The embodiments encompass a process for a multicast ingress tunnel router (MITR) and multicast egress tunnel router (METR) to manage the forwarding and receipt of multicast group traffic using BIER. The embodiments further encompass a process of a source tunnel router (TR) and target TR in a handover process that facilitates multicast traffic handling whereby the source TR is the initial point of attachment for a mobile terminal, and the target TR is the point of attachment for the mobile terminal once the handover process has completed.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

BIER Overview

BIER is an architecture for the forwarding of multicast data packets where the set of recipients in a multicast group is encoded directly in the packet headers. BIER does not require any explicit multicast distribution tree-building protocol and does not require intermediate nodes to maintain per-group state. A network device or router that supports BIER is referred to herein as a Bit-Forwarding Router (BFR). In some embodiments, regular routing control plane protocols run within a BIER domain, allowing the BFRs within that domain to exchange necessary routing information.

A BIER domain is a connected set of BFRs. This may be via direct adjacencies or by tunnels spanning non-BIER compliant portions of the network. A multicast data packet enters a BIER domain at a Bit-Forwarding Ingress Router (BFIR) and leaves the BIER domain at one or more Bit-Forwarding Egress Routers (BFERs). A BFR that receives a multicast data packet from another BFR in the same BIER domain is referred to herein as a transit BFR for that packet. Each BFR that is capable of acting as a BFIR or BFER is assigned a BFR identifier (BFR-id) that is unique within the BIER domain. When a multicast data packet enters the BIER domain, a BFIR determines the set of destination BFERs to which the packet needs to be delivered. The BFIR encapsulates the packet in a BIER header, which includes a bitstring, in which each bit represents a BFR-id. To indicate that a particular BFER needs to receive the packet, the BFIR sets (or “turns on” or “flags”) the bit in the bitstring corresponding to the BFR-id of that BFER.

A given BFR uses a unicast forwarding solution to determine the set of outgoing interfaces for a packet. When the BFR forwards a packet through a chosen outgoing interface, the BFR prunes (i.e., sets to zero or unsets) the bits in the bitmap to eliminate destination BFERs not reachable via the unicast shortest path solution on the chosen outgoing interface. When more than one outgoing interface may be used to reach a given BFER, the BFR selects one from the set. These procedures collectively ensure that only one copy of the multicast packet will be delivered to each BFER in the group. With this forwarding procedure, a multicast data packet can follow a shortest path from the BFIR to each destination BFER. Since the set of destination BFERs for a given packet is explicitly encoded into the BIER header, the packet is not delivered to destination BFERs that do not need to receive the packet. This allows for efficient forwarding of multicast traffic. This efficient forwarding is achieved without any need for transit BFRs to maintain per-group state or run a multicast tree-building protocol.

An overview of the BIER architecture is described above to aid the understanding of embodiments described herein. For clarity and ease of understanding, some details of the BIER architecture have been omitted. Those skilled in the art would understand that implementing the BIER protocol may include additional components, structures and protocols.

In multipath networks, the routing underlay will provide multiple equal cost paths from a given node to a given destination node. When forwarding multicast packets through a multipath network, it can be beneficial to take advantage of the multiple equal cost paths by load balancing among the paths. This features is known as Equal Cost Multiple Path forwarding or ECMP. Under existing BIER implementations, which path (among equal-cost paths) a node (e.g., a BFR) chooses is a random function of the entropy used. This choice can have an impact on the overall number of hops that copies of a packet traverse in the network (and thus also impact the bandwidth consumption in the network) to serve a set of destination nodes. Thus, the amount of bandwidth a BIER implementation will consume for multicasting a packet from a root node (BFIR) to a given set of destination nodes in an ECMP environment will be a random function of the entropy value specified in the packet, which can result in more bandwidth consumption than necessary.

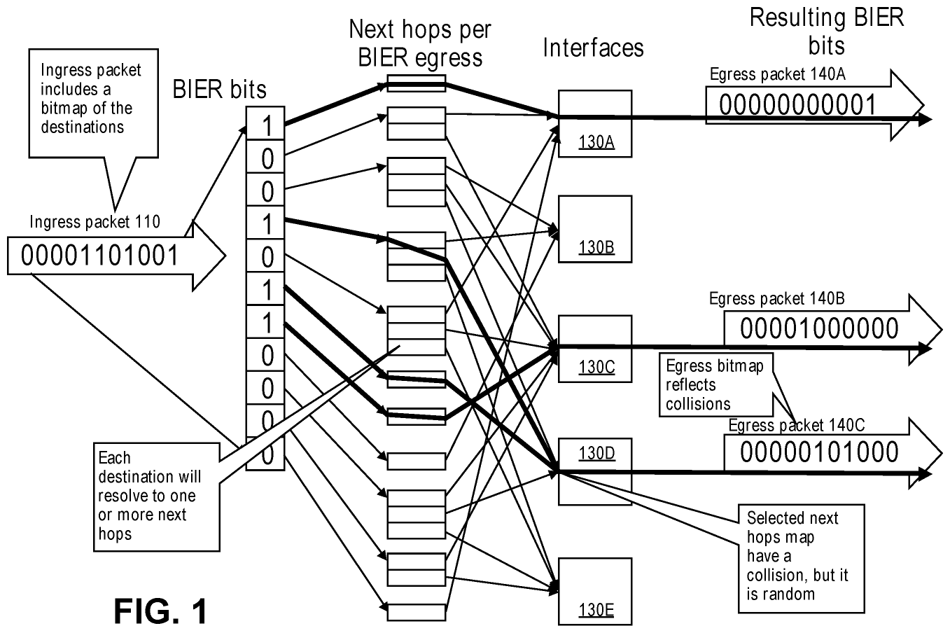

FIG. 1 is a diagram of one embodiment of the encoding of a bit indexed explicit replication (BIER) bitmap for forwarding multicast traffic. As illustrated, an ingress packet 110 is encapsulated in a BIER header having a bitstring of “00001101001.” The bitstring has 11 bits, where each bit corresponds to a BFR-id of a BFR. By convention, the least significant (rightmost) bit in the bitstring is designated as bit 1 and the most significant (leftmost) bit is designated as bit 11 (with bits in between designated accordingly). Bit 1 corresponds to BFR-id 1, bit 2 corresponds to BFR-id 2, and so on. The bitstring identifies the set of destination BFRs (e.g., BFERs) to which a copy of the ingress packet 110 should be delivered. As shown, bits 1, 4, 6, and 7 are set (or “turned on”) in the bitstring of the ingress packet, indicating that a copy of the ingress packet should be delivered to BFRs having BFR-ids 1, 4, 6, and 7, respectively. The bitstring that identifies the destination nodes to which a copy of a given packet should be delivered is referred to herein as a destination bitstring associated with the given packet.

In an ECMP environment, each destination BFR may be reached on a shortest path using one or more next hops. For example, the destination BFRs corresponding to bit 1, bit 6, and bit 7, respectively, only have a single outgoing next hop that is on the shortest path. The destination BFR corresponding to bit 4, however, can be reached on the shortest path via any one of three next hops. A packet can be forwarded to a next hop through a corresponding outgoing interface (e.g., interfaces 130A-E).

Since there is only a single next hop that can be used to forward the packet towards the destination BFR corresponding to bit 1 (i.e., the BFR having BFR-id 1), the packet is forwarded towards the destination BFR corresponding to bit 1 using that next hop through interface 130A as egress packet 140A. Also, since the destination BFR corresponding to bit 1 is the only destination BFR to be reached through that next hop, the egress packet 140A is encapsulated in a BIER header having a bitstring in which all bits are cleared except for bit 1. Similarly, since there is only a single next hop that can be used to forward the packet towards the destination BFR corresponding to bit 7, the packet is forwarded towards the destination BFR corresponding to bit 7 using that next hop through interface 130C as egress packet 140B. Also, since the destination BFR corresponding to bit 7 is the only destination BFR to be reached through that next hop, the egress packet 140B is encapsulated in a BIER header having a bitstring in which all bits are cleared except for bit 7.

The destination BFR corresponding to bit 4 can be reached using any one of 3 different next hops. The next hop chosen among the equal-cost next hops is based on an entropy value specified in the packet. For example, the next hop can be chosen by calculating the entropy modulo next hop count. As such, next hop selection is a random function of the entropy value in the BIER packet header.

In this example, the next hop chosen to reach the destination BFR corresponding to bit 4 and the next hop to reach the destination BFR corresponding to bit 6 is the same. As such, the packet is forwarded towards both BFRs using the same next hop through interface 130D as egress packet 140C. The egress packet 140C is encapsulated in a BIER header having a bitstring in which all bits are cleared except for bits 4 and 6. In this example, the next hop chosen to reach the destination BFR corresponding to bit 4 collides with the next hop to reach the destination BFR corresponding to bit 6, but this collision is essentially a random function of the entropy value specified in the packet. This randomness involved in choosing the next hop can have an impact on the overall number of hops that copies of a packet traverse in the network (and thus also impact the bandwidth consumption in the network) to serve a set of destination nodes. In other words, the amount of bandwidth a BIER implementation will use for multicasting a packet to a given set of destination nodes in an ECMP environment will be a random function of the entropy value specified in the packet, which can result in consuming more bandwidth than necessary.

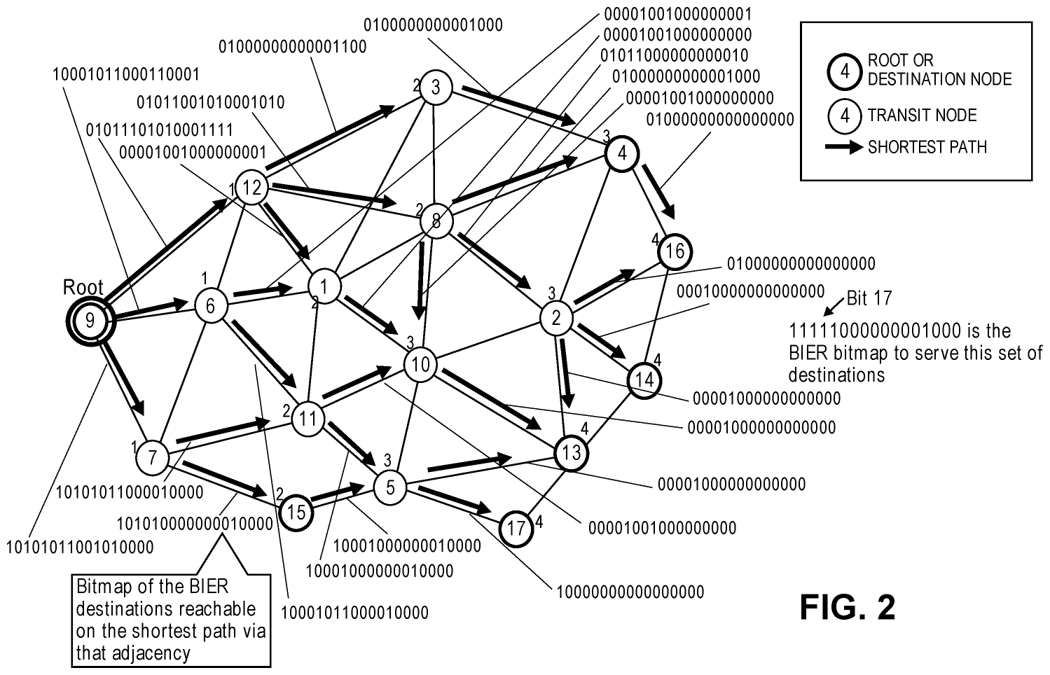

FIG. 2 is a diagram of one embodiment of shortest path forwarding in a network implementing BIER. The network includes 17 nodes (nodes 1-17). Each node is a BFR. Node 9 is a root node or BFIR. The BFIR is to forward a packet towards a set of BFERs. In the example shown, the destination bitstring associated with the packet is “11111000000001000.” As used herein, the destination bitstring associated with a packet refers to the bitstring that identifies the nodes to which a copy of that packet should be delivered. The destination bitstring in this example indicates that nodes 4, 13, 14, 15, 16, and 17 are the nodes to which a copy of the packet should be delivered. The remaining nodes (the nodes that are not a BFIR (root node) or a BFER (destination node)) are general BFRs or transit nodes. The arrows indicate the links that are on the shortest path from the BFIR to the other nodes in the network. The number adjacent to each of the transit nodes and BFERs indicates the number of hops that it takes to reach that node on a shortest path starting from the BFIR. For example, nodes 6, 7, and 12 are designated with a number 1 since they can be reached from the BFIR on a shortest path using 1 hop. Nodes 1, 3, 8, 11, and 15 are designated with a number 2 since they can be reached from the BFIR on a shortest path using 2 hops. Nodes 2, 4, 5, and 10 are designated with a number 3 since they can be reached from the BFIR on a shortest path using 3 hops. Nodes 13, 14, 16, and 17 are designated with a number 4 since they be reached from the root node on a shortest path using 4 hops. The bitstring corresponding to each arrow is an outgoing interface bitstring associated with that adjacency or outgoing interface. The outgoing interface bitstring associated with an adjacency or outgoing interface identifies the nodes that are reachable on a shortest path via that adjacency or outgoing interface. For example, the adjacency from node 7 to node 15 is associated with bitstring “10101000000010000.” This indicates that nodes 5, 13, 15, and 17 can be reached from node 7 on a shortest path via this adjacency. The adjacency from a node X to a node Y may be denoted herein as adjacency X-Y. For example, the adjacency from node 7 to node 15 may be denoted as adjacency 7-15.

Cellular Communication Network Architecture with LISP

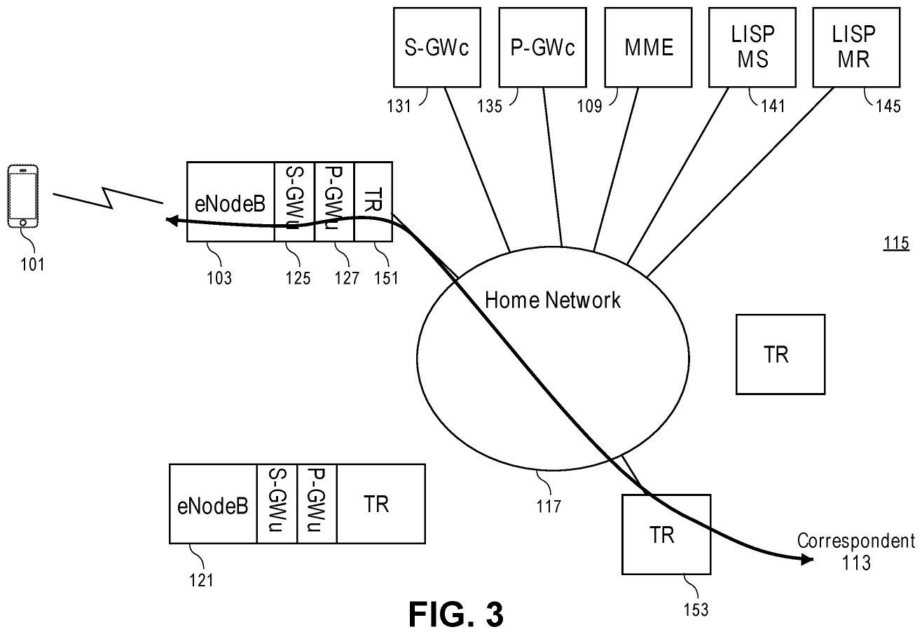

FIG. 3 is a diagram of one embodiment of a cellular network implementing locator identifier separation protocol (LISP). Cellular communication networks enable user equipment (UE) 101, such as cellular phones and similar computing devices, to communicate using spread spectrum radio frequency communication. As shown in FIG. 3, the UE 101 communicates directly with a radio access network (RAN). The RAN includes a set of base stations such as evolved universal terrestrial radio access network (E-UTRAN) nodes, referred to as E-UTRAN node B or eNodeB 103. This example architecture for a cellular communication system is modified from long term evolution (LTE) cellular communication architecture developed by the 3^{rd} generation partnership project (3GPP) to utilize LISP to facilitate mobility in the network. In this example, UE 101 communicates with a eNodeB 103 of the network. The eNodeB 103 interfaces with a packet core network or evolved packet core (EPC) that connects the UE to other devices in the cellular communication network and with devices external to the cellular communication network.

The EPC and its components are responsible for enabling communication between the UE 101 and other devices both internal and external to the cellular communication system. The EPC includes a serving gateway (S-GW), a packet gateway (P-GW), a mobility management entity (MME) 109 and similar components. Additional components are part of the EPC (e.g., a home subscriber service (HSS)), but the components with less relevance to the handling of the UE 101 and its mobility have been excluded for clarity and to simplify the representation. The UE 101 may change the eNodeB 103 through which it communicates with the network as it moves about geographically. The MME 109, S-GW and P-GW coordinate to facilitate this mobility of the UE 101 without interruption to any ongoing telecommunication session of the UE 101.

The MME 109 is a control node that, among other duties, is responsible for determining an S-GW that the UE 101 is to communicate with at attach time and when handovers between eNodeBs 103 in the RAN occur. The MME 109 has other responsibilities including idle mode communication with the UE 101, which includes paging and text retransmissions.

The S-GW and the P-GW provide anchor points for a UE 101 enabling various types of transitions that facilitate the mobility of the UE 101 without the UE 101 losing connections with other devices. The S-GW routes and forwards data to and from the UE 101 while functioning as a mobility anchor point for the UE 101 handovers between eNodeBs 103 and between long term evolution (LTE) and other 3GPP technology. The P-GW provides connectivity between the UE 101 and external data packet networks by being a fixed anchor point that offers the UE's Internet Protocol (IP) address into a routable packet network. The S-GW and P-GW may belong to a common operator, or different operators depending on whether the UE 101 is currently being served by a home network 117 or visited network.

As shown in the example simplified network of FIG. 3, a UE 101 communicates with the EPC via the eNodeB 103 to reach a correspondent 113. In some embodiments, the traffic from the UE 101 would traverse the connected eNodeB 103, the S-GW, and P-GW, to reach a correspondent 113. If the correspondent is a mobile device, the path to that correspondent may also traverse a P-GW, S-GW and eNodeB which are also subtended to the common packet data network. The correspondent 113 can be any device capable of receiving the traffic from the UE 101 and sending traffic to the UE 101 including cellular phones, computing devices and similar devices that may be connected through any number of intermediate networking or computing devices.

In this example illustrated embodiment, LISP is utilized to facilitate the mobility of the UE 101 and the S-GW and P-GW are distributed and divided into a dataplane S-GWu 125 and P-GWu 127 and control plane S-GWc 131 and P-GWc 135. The S-GWu 125 and P-GWu 127 are co-located with an eNodeB 103, such that a UE 101 being served by a home network can connect to the network via the S-GWu 125 and P-GWu 127 functions at or near the eNodeB 103. This is facilitated by tunnel routers (TRs) 151, 153 that forward the data traffic between a UE 101 and correspondent 113 using LISP. TRs encapsulate traffic using LISP where destination devices are associated with endpoint identifier (EIDs) and a routing locator (RLOC). In LISP the device identity (EID) is separate from its location (RLOC) and the LISP mapping system track this relationship and can be queried by the TRs to determine forwarding information for an end device as it changes locations. For example, where the UE 101 may move to connect to another eNodeB 121. The UE 101 could move from a source eNodeB 103 to a target eNodeB 121 without interruption to the communication session with the correspondent 113. The state of the S-GWu and/or P-GWu can be transferred or synchronized between the GW instances at the source eNodeB 103 and those at the target eNodeB 121. Any method or process for coordinating the transfer of state and related configuration data from the source eNodeB 103 to the target eNodeB 121 can be utilized.

In this example, functions of both the S-GW and the P-GW are distributed. However, one skilled in the art would understand that this configuration is provided by way of example and not limitation. The distribution of the functions of the S-GW and P-GW in combination with the use of LISP can be utilized in other configurations where different permutations of the functions are distributed. The control plane functions of the S-GW and P-GW, referred to as S-GWc 131 and P-GWc 135, respectively, remain in the EPC. Similarly, the MME 109 remains in the EPC and continues to perform the same functions.

The EPC 115 has been augmented with a LISP map server (MS) 141 and a LISP map resolver (MR) 145. The LISP MS 141 manages a database of EID and RLOC mappings that are determined from communication with TRs 151, 153. The LISP MS 141 receives EID information about connected devices from TRs 151, 153 that are stored in the database and associated with the respective TRs 151, 153. Similarly, the LISP MR 145 handles map requests from the TRs 151, 153 when serving as ingress TRs and uses the database to find an appropriate egress TR to reach a destination EID. Thus, these components enable the distributed mobility of the S-GWu 125 and P-GWu 127 along with the use of TRs 151, 153.

The distributed S-GWu and/or P-GWu can be instantiated at each eNodeB with a logically separate instance for each connected UE 101. Thus, the state and similar configuration are specific to the UE 101 and can be transferred or shared with other instances at other eNodeBs to facilitate handover operations. All S-GWu and/or P-GWu instances are controlled by S-GWc and P-GWc instances. Each such control instance may control one or several corresponding data plane instances. This enables the controllers to coordinate amongst the data plane instances while preserving the external appearance and interfaces of a single monolithic gateway.

Overview

Implementing and supporting multicast in a network where end devices, like user equipment, is mobile present a number of difficulties and potential inefficiencies. If implemented as a standard network based multicast they may be a significant churn, i.e., updates to the state of the multicast forwarding in the underlying network. There will be signaling of the change in the location of the end devices and their multicast memberships and the associated forwarding, as a consequence of every mobility event, i.e., each time that an end device alters its attachment point to the network. If multicast is implemented as an overlay, e.g., using edge replication, then there will a large number of duplicates copies of a multicast packets that transit the links close to the root (i.e., source) of each multicast distribution tree. This is an inefficient use of bandwidth and puts considerable resource requirements on those nodes in the network closest to the source of a multicast group.

The embodiments provide a method and system that minimize churn and the unnecessary duplication of multicast packets near the source of a multicast group. The embodiments combine LISP networks with BIER. Tunnel routers and LISP encapsulation are utilized with multicast traffic and LISP manages the location of end devices transparent to the multicast protocols and multicast forwarding. When an egress tunnel router (ETR) services an EID (i.e., an end device) that has interest in a multicast group, the ETR registers interest with the LISP mapping system and instantiates local state to relay copies of received multicast traffic for that group to the UE. An ingress tunnel router (ITR) services a multicast source. When the ITR queries the map server and gets a list of RLOCs that have registered interest in a multicast group, the ITR can use this to construct a BIER bitmap of the RLOCs of the ETRs that should receive a copy of the multicast packet. It is also possible to envision embodiments whereby the server or other intermediate node constructs the map from the information in the map server and presents it to the ITR.

The embodiments provide a system and process such that the ITR has sufficient information to map RLOCs to BIER bit positions. This bitmap is used in the construction of network based multicast packets such that the network performs more efficient replication of packets to the leaf RLOCs of the multicast distribution tree for a given multicast group. In other embodiments, a LISP mapping system could be replaced with any form of repository of knowledge of what RLOCs or end systems in general had interest in a multicast group. For sake of clarity and conciseness the example of a LISP implementation is provided. However, one skilled in the art would appreciate that any comparable technology could be utilized in place of LISP. Intermediate System—Intermediate System (IS-IS) support of shortest path bridging would be an exemplar where multicast interest was advertised using the interior gateway protocol (IGP). However, the embodiments address issues related to mobility and enable keeping state out of the core of the network.

The embodiments provide advantages over the prior art. The embodiments recognize that the LISP mapping system when used in the manner set forth in the embodiments is an ideal vehicle for communicating the information for construction of BIER packet headers. BIER being stateless for multicast only requires that the ingress point into the multicast distribution tree (i.e., the root or source) have knowledge of the leaf nodes (i.e., the subscribers or edge devices associated with the subscribers or end devices), which is precisely what BIER can obtain from the LISP mapping system according to the embodiments. As LISP is an overlay solution the embodiments abstract the leaf nodes to being the RLOC of the ETRs associated with the leaves, which enables network assisted multicast in the underlay to be employed.

The embodiments also take advantage of BIER being stateless, thus, mobility events merely require that the set of RLOCs known at the ITR for the multicast group be updated rather than more involved signaling as would be required in the prior art. A subscriber to a multicast group registers interest in the multicast group at an associated ETR. This results in the updating of the mapping system by the ETR notifying the LISP mapping system of this change and thereby the ITR can query the LISP mapping system to obtain a current set of ETRs corresponding to multicast group receivers. The embodiments have the desirable property of not resulting in any core signaling based on this use of the LISP mapping system to convey information about multicast group membership.

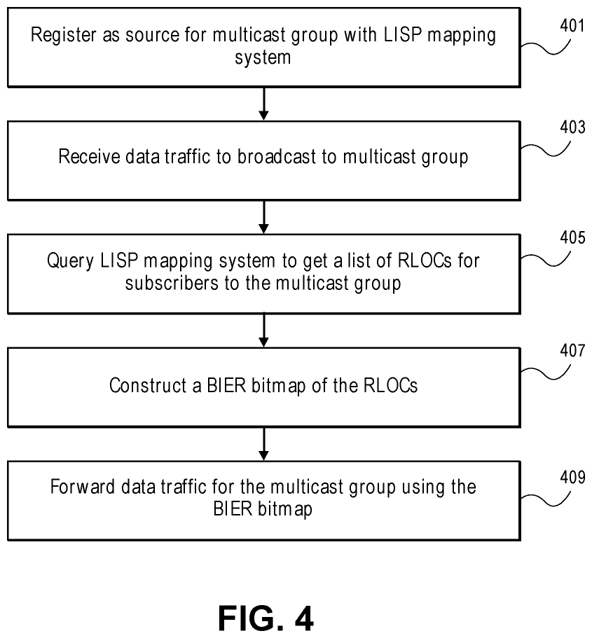

FIG. 4 is a flowchart of one embodiment of a process for a multicast ingress tunnel router (MITR) to forward multicast traffic to a multicast group. The process for facilitating multicast group traffic handling in the combination BIER and LISP embodiments is implemented in the tunnel routers of the network, specifically ITRs and ETRs that here function as MITRs and METRs, respectively. The MITRs are the nodes executing TRs closest to the sources of the multicast group and that serve as the root of the multicast distribution tree that determines the forwarding of traffic from the source node to the leaves. The MITR may receive a notice from a source of a multicast group that begins the illustrated process. The MITR registers with the LISP mapping system as a source for a multicast group (Block 401). The multicast group can be identified using any multicast group identifier (e.g., with the Internet Protocol (IP) address for the multicast group). In some embodiments, the MITR can register with the LISP mapping system by sending a join group message to the LISP MR.

The MITR may then begin to receive multicast group traffic to be broadcast to the multicast group (Block 403). The source of the multicast group can forward this traffic to the MITR or similarly send the data traffic to the MITR addressed the multicast group using the multicast group identifier. The MITR can then query the LISP mapping system MS (e.g., by sending a request to the LISP map server (MS) to get a list of RLOCs for the METRs servicing the subscribers of the multicast group (Block 405). The response can be received from the LISP MS using any format and with any number of RLOCs identified depending on the size of the multicast group. If there are multiple subscribers associated with the same METR and RLOC then the RLOC does not need to be repeated in the provided list to the MITR. In other embodiments, the query to the get a list of RLOCs may be performed before receiving traffic for a multicast group. The MITR may send such queries at fixed intervals, when a source registers with the MITR or at similar timings.

With the RLOC information and a knowledge of all of the possible METRs in the network, the MITR can construct a BIER bitmap of the RLOCs (Block 407). The BIER bitmap sets each location in the bitmap associated with one of the identified RLOCs with a value of ‘1.’ Thereafter, the multicast traffic for that multicast group can be sent using this BIER bitmap where intermediate nodes implement BIER and forward and manipulate the BIER bitmap accordingly. The MITR can update the BIER bitmap in response to receiving new packets destined for the multicast group, at set intervals, or in response to notices of updates in the multicast group membership received from the mapping system.

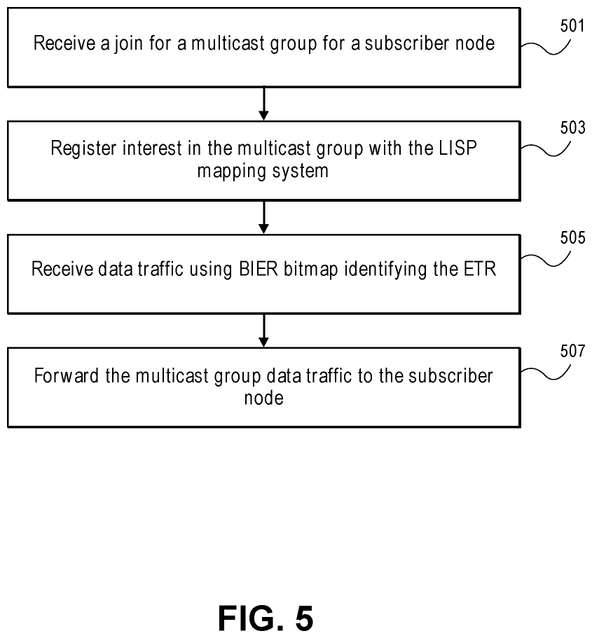

FIG. 5 is a flowchart of one embodiment of a process for a multicast egress tunnel router (METR) to receive multicast traffic for a multicast group. The METR may initiate the process illustrated in response to receiving a request from a subscriber end node or device to join a multicast group (Block 501). The multicast group may be identified with a multicast group identifier such as the IP address for the multicast group. The METR can then register interest (i.e., subscription) in the multicast group with the LISP mapping system (Block 503). The METR can send a message to the LISP MR identifying the multicast group with the multicast group identifier. The METR tracks the EIDs associated with a multicast group and maintains registered interest as long as the local community of interest has at least one member. In some instances, there may be multiple EIDs associated with a given multicast group. If any of these EIDs request to leave the multicast group either the METR or the LISP mapping system must track whether there are any EIDs still interested in the multicast group. If not, then the LISP mapping system is notified to remove the RLOC of the METR from association with the multicast group. The METR can send messages to the LISP MR to register interests and send leaves related to a particular multicast group.

Once registered, the METR may begin to receive multicast traffic from the MITR and source of the multicast group (Block 505). The multicast traffic can then be forwarded to each of the end devices with EIDs tracked and associated with the multicast group by the METR (Block 507). This process of forwarding traffic to the end nodes or devices associated with the corresponding METR can continue until any or all of these end nodes or devices leave the multicast group or move to another location in the network, in which case the METR leaves the multicast group even if the end nodes or devices do not. A mobility handover process is described further herein below. The process at the METR for handling an end node that leaves a multicast group is an inversion of this process with variations dependent on whether the LISP mapping system or the METR determines how many EIDs are associated with the multicast group attached at the METR.

Handover Process

As described above, when an MITR queries the LISP mapping system and gets a list of RLOCs for a multicast group, it uses this to construct a BIER bitmap of the RLOCs that should receive a copy of the multicast packet. This BIER bitmap is used in the construction of network based multicast packets such that the network performs more efficient replication of packets to the leaf METRs and associated EIDs. However, in a network where nodes are mobile this presents a number of problems for handling that mobility. In particular, the transition of an end node with its EID from one attachment point in the network to another. This is referred to as a handover process that involves a source TR and a target TR. The source TR is the TR that the transitioning device is initially attached to. The target TR is the TR that the transitioning device is moving to attach to. In an LTE system both the source and target TRs are aware of the intended handoff prior to it actually being executed.

A source TR that functions as a METR for a multicast group may have more than one EID as a leaf for that Multicast group. During a handover multicast packets for the transitioning device are continuing to be received. Also, multiple end devices may be members of the multicast group and attached to the source TR. This makes the presence or absence of multicast traffic at either the source or target TRs during handover an unreliable indicator of whether the head end of the multicast broadcast has switched or not. A ‘head end switch’ refers to the MITR and the source altering the destination of packets broadcast to a multicast group using BIER bitmaps to identify METRs.

At the target TR, the target TR may have preexisting EIDs that are leaves for a multicast group such that multicast traffic for that multicast group is already available at the moment of handover at the target TR. The head end switch may be slow such that there is a significant gap between handover, and the start of arrival of multicast traffic intended for the leaf.

Table I illustrates the various handover scenarios:

TABLE I

| Case | Before Handoff | After Handoff | Comments |
|---|---|---|---|
| 1 | Source TR = member | Source TR = not | EID is only recipient |
| | Target TR = not | Target TR = member | |
| 2 | Source TR = member | Source TR = member | Multiple EIDs were recipient |
| | Target TR = not | Target TR = member | at source |
| 3 | Source TR = member | Source TR = not | Multiple EIDs were recipient |
| | Target TR = member | Target TR = member | at target |
| 4 | Source TR = member | Source TR = member | Multiple EIDs were recipient |
| | Target TR = member | Target TR = member | at both source and target |

The table identifies each of the permutations of the membership of the source TR and target TR for a given multicast group. Case 1 is the only case that could be handled by a basic handover procedure without loss, packet duplication or misordering. For case 4, the ITR does not know a handoff occurred, because there was no change in the RLOCs in the receiver list. From the point of view of the ITR, there was no change to the set of RLOCs with registered interest in the multicast group. In addition, any synchronization transactions the ITR originates will be received by all recipients. An ITR originating multicast traffic for a given EID (the MITR), may not be originating unicast traffic. Thus, the handover process cannot depend on unicast messaging to coordinate multicast handoff.

The embodiments focus on the case where the handover procedures are “break before make,” which is to say the endpoint device (e.g., a UE) disconnects from the source TR prior to connecting to the target TR. One skilled in the art would also appreciate that these procedures could be adapted to changing the preferred interface of delivery where the endpoint was simultaneously multihomed. The embodiments reduce the problem of handover to deciding whether the source TR is required to forward multicast traffic for a handed over EID to the target TR in order to ensure the stream is available and not duplicated with a minimum of loss during the handover procedure. This addresses the interval in time between the EID handover, and when the ITR for the multicast group (MITR) adds the target TR to the multicast distribution tree (MDT). This requires knowledge of the current set of recipient RLOCs of the MDT at the source TR. More specifically the source TR needs knowledge of whether the target TR is already a member of the MDT at the time of handover and if not, when in the handover process the target TR becomes a member.

The embodiments provide that if the source TR has knowledge of whether the target TR already subscribes to the multicast groups of the EID that is transitioning, then the source TR will have sufficient knowledge to know if it needs to proxy as a multicast source (i.e., function as a re-encapsulating TR) until the MITR takes over by adding the target TR to the MDT (i.e., the head end update completes).

To achieve this, every time the MITR has a change in the set of leaf RLOCs, it generates a “multicast control message” indicating via any suitable encoding, the list of receiving RLOCs for the multicast group into the MDT. A BIER bitmap is an efficient exemplar of such an encoding. Each METR that has EIDs subscribing to the multicast group can receive a copy, and will retain a copy of the control message information. In some embodiments, the handover messaging between the source TR and target TRs can be a LISP EID handover request or similar messaging that conveys a basic handshake between the source TR and target TR to alert the target TR of the handover and the EID of the associated transitioning device.

This LISP EID handover message can be augmented to also indicate the multicast groups that the EID subscribes to in addition to the EID of the end device. This permits the target TR to proxy any necessary operations to join the MDT on behalf of the EID. In some embodiments, the EID can issue join messages immediately upon connection to the target TR as an alternative. When the source TR issues a LISP EID handover request it also checks the retained multicast group control information for each group the EID subscribes to in order to see if the target TR is also a member of the MDT for that multicast group.

For each multicast group that the EID subscribes to for which the target TR is not a member, it acts as a re-encapsulating TR (RTR) and forwards received multicast traffic for the subscribed multicast group to the target TR until such time as either a timeout occurs, or a new multicast control message is received from the MITR indicating that the target TR is now a recipient of the MDT for that multicast group.

When the target TR receives a LISP LID handover request it checks if it is already a member of the MDT for each multicast group identified in the handover request message. If it is not, it will issue the necessary LISP join operations to the LISP MS, and perform the local operations necessary to relay multicast traffic to the EID as soon as it successfully connects to the target TR. The target TR adds the EID as a recipient for traffic addressed to the multicast group purely as a local operation immediately upon the EID successfully connecting.

The target TR in effect promiscuously receives traffic for the multicast group, which it may receive from the source TR or the MDT respectively. The target TR may buffer multicast traffic if either redirected multicast or directly sent multicast traffic arrives before the UE connects to the target TR.

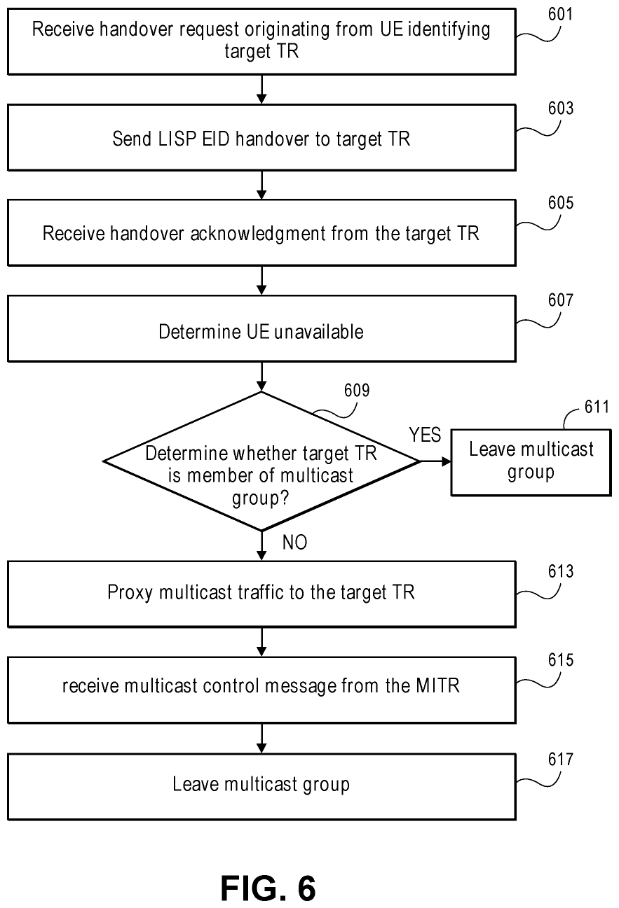

FIG. 6 is a flowchart of one embodiment of a process for a source tunnel router (TR) in a multicast handover process. The process at the source TR for the handover process is detailed in the flowchart. The process begins in response to receiving a handover request message originating from an end user device or UE that identifies a target TR (Block 601). For clarity, the example of the handover of a UE is used herein.

The source TR sends a LISP EID handover message to the target TR (Block 603) or any similar notification. The message can include the EID of the UE and the group IDs of the multicast groups it belongs to. The source TR receives a handover acknowledgement from the target TR (Block 605). At some point the source TR determines (by notification or lack of signal) that the UE is no longer available (i.e., not attached) (Block 607). This may take place at other points in the sequence as well.

The source TR determines whether the target TR is a member of the multicast groups that the UE belongs to (Block 609). If the target TR belongs to the multicast group, then the process can complete. Where there are multiple group memberships this process may be separately instanced for each of them. If the UE was the last member of the multicast group, then the source TR may leave the multicast group (Block 611).

If the target TR is not a member of the any of the multicast group(s) that the UE subscribed to, then the source TR can proxy (i.e., replicate and forward) the multicast traffic for those groups to the target TR (Block 613). A multicast control message may be received from the MITR indicating that the target TR is now a member of a multicast group (Block 615). At this point source TR, can then stop acting as an RTR for that group and if the UE was the last member of the multicast group attached to the source TR, then the source TR can leave the group (Block 617). Eventually all multicast groups that the source TR acted as an RTR for would be recognized as being delivered directly to the target TR.

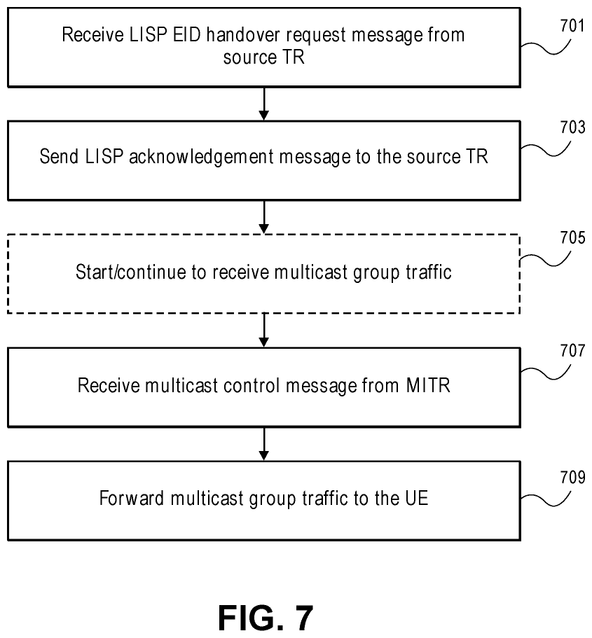

FIG. 7 is a flowchart of one embodiment of a process for a target TR in a multicast handover process. This process is described in relation to the handover of a UE and would be understood to relate to any endpoint node or device. The process for the target TR is initiated in response to receiving the LISP EID handover message from the source TR (Block 701). The target TR sends a LISP acknowledgment message to the source TR, thereby indicating it is aware of the coming handover of the UE (Block 703). The received message included the EID of the UE and identifies the multicast groups the UE subscribes to. Depending on the current multicast group membership of the target TR, the target TR may join those multicast groups it is not already a member of and either start or continue receiving multicast group traffic (Block 705). The target TR will receive a multicast control message from each MITR indicating that the target TR is now a member of the respective multicast group of the UE (Block 707). Upon attachment of the UE, the target TR can forward the multicast traffic to the UE (Block 709). In other cases, the target TR may initiate joining multicast groups on behalf of the UE where the target is not a member, but may not receive the respective multicast control messages before the UE attaches. In either case, the target TR forwards the available multicast traffic to the UE for the multicast groups associated with the UE.

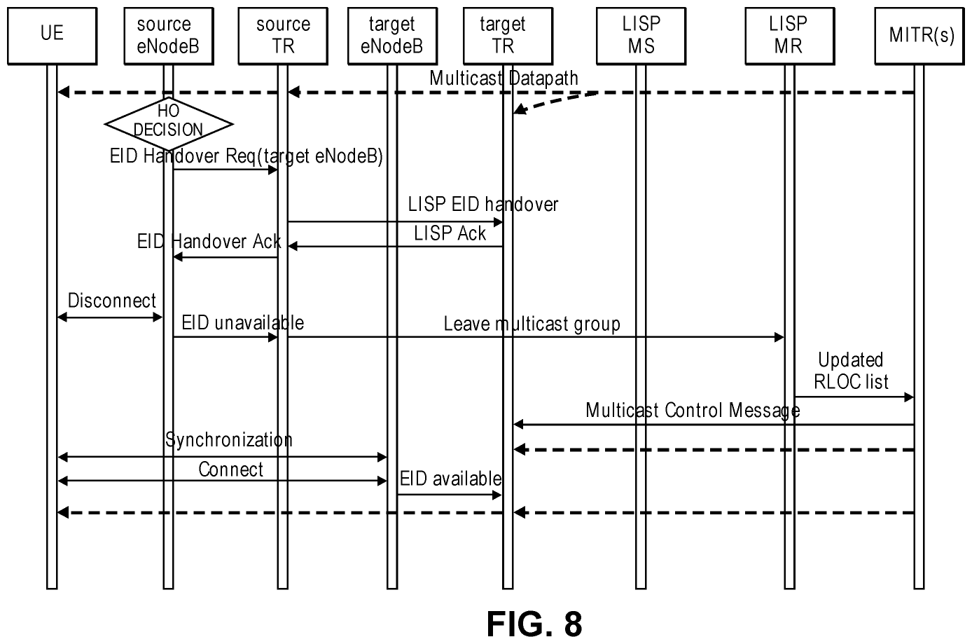

FIG. 8 is a timing diagram of one embodiment of a handover call flow where both the source TR and target TR are members of a multicast group. This example implementation is specific to a 3GPP or 3GPP LTE architecture, however, one skilled in the art would understand the processes, structures and principles are applicable to other architectures. This timing diagram is provided by way of example to help illustrate the handover process. In this example, multicast traffic is already being sent to both the source TR and the target TR when an EID handover decision is made by a source eNodeB associated with the source TR. This is may be in response to the source eNodeB receiving a handover request from the UE. The source eNodeB sends an EID handover request identifying the target eNodeB to the source TR. The source TR then sends a LISP EID handover message to the target TR identifying the UE and the multicast groups to which the UE belongs using the EID and RLOCs, respectively. The target TR sends an acknowledgement to the source TR. The source TR then sends an EID handover acknowledgement to the source eNodeB.

The UE disconnects from the source eNodeB, as it switches to the target eNodeB, which causes the source eNodeB to send an EID unavailable message to the source TR. The source TR, in response, leaves the multicast group via a message to the LISP MR. The LISP MR notifies the MITR with an updated RLOC list for the multicast group without the source TR listed. The MITR sends out a multicast control message with the RLOC list that is received by the source TR and the target TR. The source TR can cease forwarding the multicast traffic when the multicast control message indicates the target TR is a member of the multicast group. The MITR continues to send multicast traffic to the target TR which may buffer it in anticipation of the UE connecting. The UE attaches and synchronizes with the target eNodeB, which sends and EID available message to the target TR. The target TR can then begin to forward all buffered multicast traffic received from the source TR and directly from the MITR to the UE.

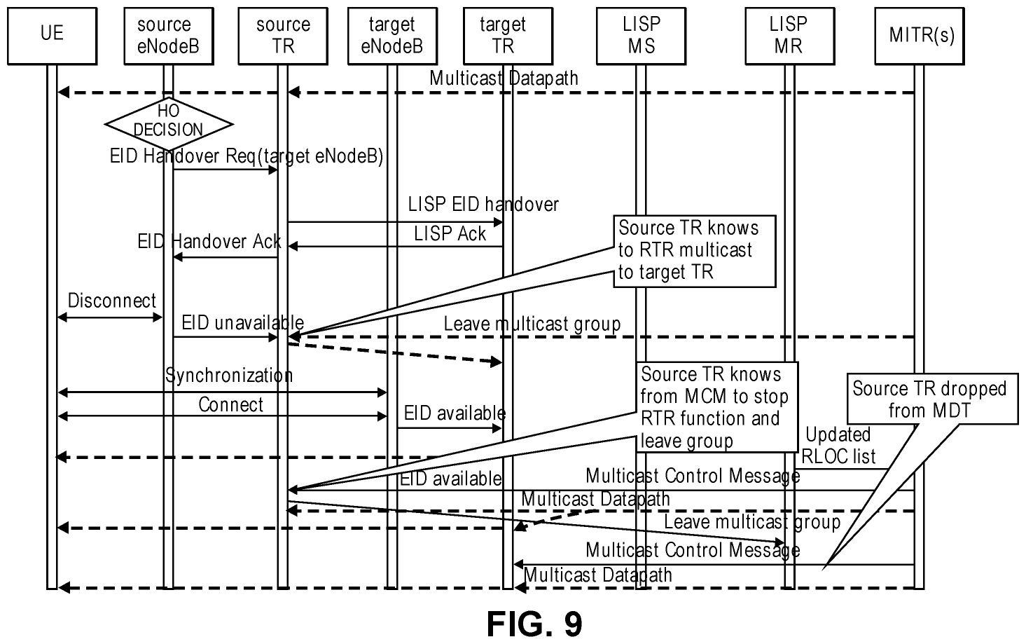

FIG. 9 is a timing diagram of one embodiment of a handover call flow where the target TR is not a member of the multicast group. In this case, multicast traffic is not being sent to the target TR. This process proceeds as with the case where the multicast traffic is being sent to the TR up until the source TR receives notification that the EID is unavailable. At this point the RTR functions begins to send the multicast traffic to the target TR which may choose to buffer it in anticipation of the UE connecting. After the UE connects with the target eNodeB and the target TR receives an EID available message, then the target TR beings to forward multicast traffic from the source TR to the UE. The target TR sends a join to the LISP MR and when the resulting change propagates to the MITR a multicast control message with an updated RLOC list is sent on the MDT. When the source TR receives the updated multicast control message in which the receiver list includes the target TR, it ends the RTR function and if there are no other local subscribers leaves the multicast group.

The embodiments allow for certain types of errors to be handled. Errors can occur when the multicast control message is not delivered by a reliable mechanism. This can result in several outcomes at the time of handover. For example, the source TR thinks the target TR is a member of the MDT when it isn't. In which case, there will be an interruption of multicast delivery until the MITR adds the target TR to the MDT. In another case, the source TR may think the target TR is not member of the MDT when it is. In this case, there will be delivery of duplicate packets until the timeout occurs or another change in group membership triggers the sending of a multicast control message by the MITR. In a further case, the source TR does not receive a control message and continues performing RTR functions after target TR becomes part of MDT. In this case, duplication will occur until the RTR function timeout occurs. The likelihood of these errors can be mitigated by more frequent issuance of multicast control messages by the MITR.

The embodiments can also manage some race conditions related to the handover process. If the target TR issues a leave request at the same time the source TR initiates a handover, then the source TR believes the target TR is a member of MDT and does not perform RTR function during the handover. Latency in performing a “leave” operation should mitigate this race condition. Where the target TR has already issued a join at the time the source TR initiates the handover request, then the source TR should see the associated multicast control message and terminate RTR function with no real effect. When multiple source TRs perform near simultaneous handovers of EIDs subscribing to a common multicast group for which the target TR was not previously a member, then this results in multiple TRs acting as an RTR for the multicast group towards the target TR which can be mitigated by allowing the target TR to be promiscuous only by class of source (MDT or a single RTR as a multicast source).

Thus, the embodiments of the process and system as described provide advantages over the prior art. The embodiments provide an elegant and generalized multicast control message process such that the source TR has knowledge of the state of any possible target TR with respect to the current multicast distribution tree when performing a handover. The message being multiplexed with the multicast stream means it also has instantaneous knowledge of when a target TR joined an MDT and can immediately stop proxying traffic as an RTR. This makes the operation effectively lossless and duplicate free for that scenario although ordering guarantees are not a part of the process.

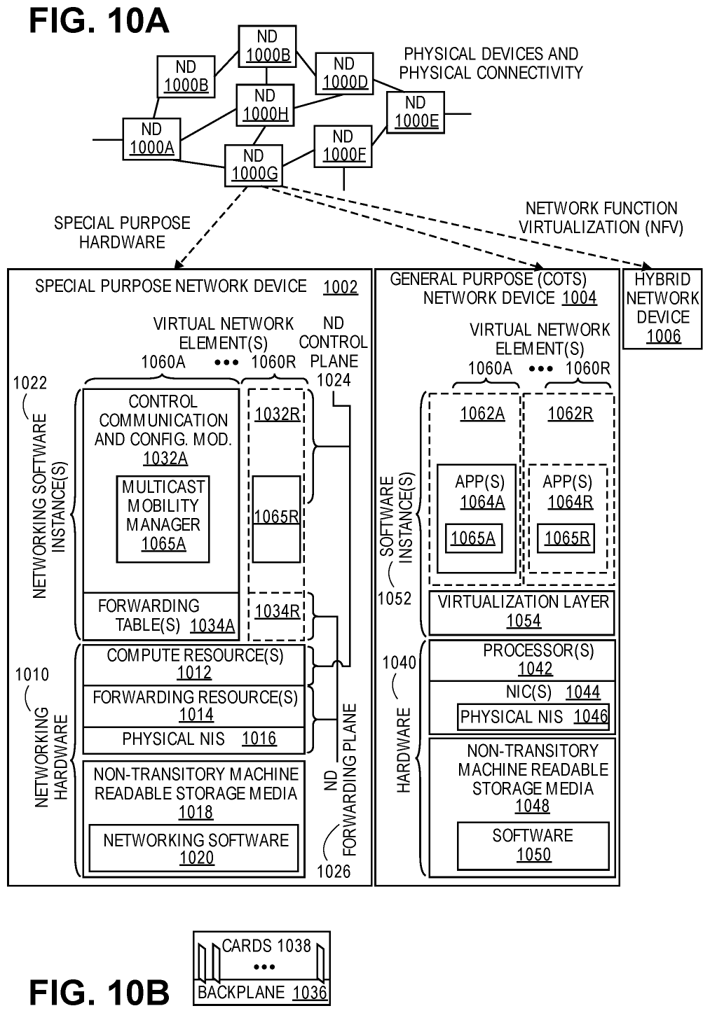

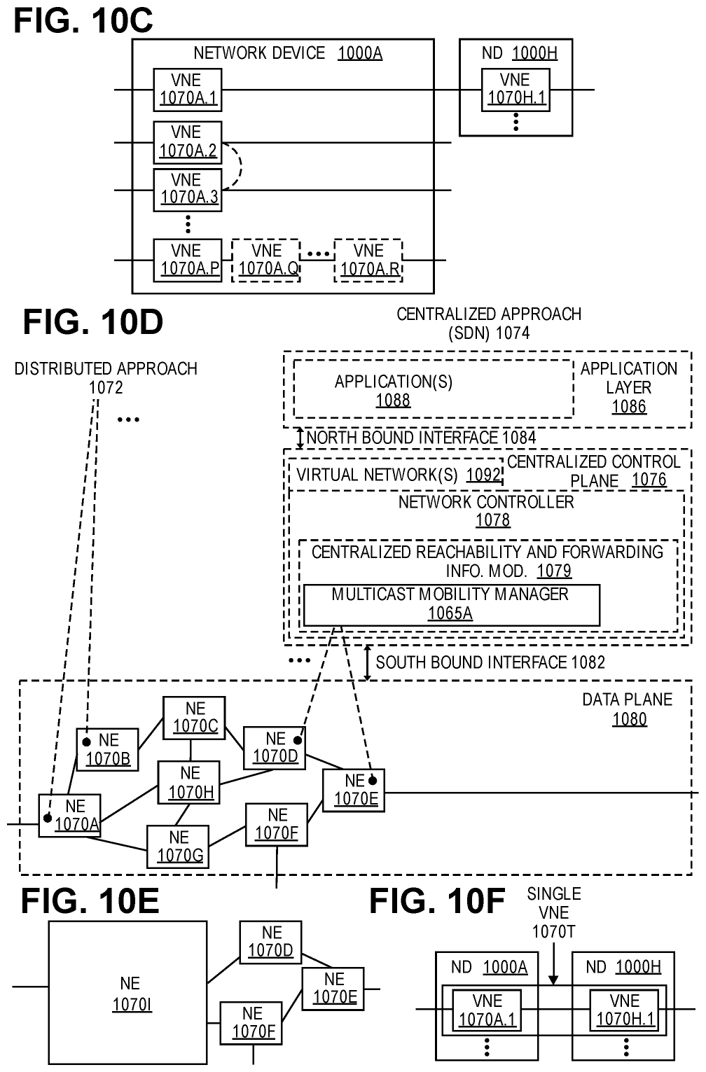

FIG. 10A illustrates connectivity between network devices (NDs) within an exemplary network, as well as three exemplary implementations of the NDs, according to some embodiments of the invention. FIG. 10A shows NDs 1000A-H, and their connectivity by way of lines between 1000A-1000B, 1000B-1000C, 1000C-1000D, 1000D-1000E, 1000E-1000F, 1000F-1000G, and 1000A-1000G, as well as between 1000H and each of 1000A, 1000C, 1000D, and 1000G. These NDs are physical devices, and the connectivity between these NDs can be wireless or wired (often referred to as a link). An additional line extending from NDs 1000A, 1000E, and 1000F illustrates that these NDs act as ingress and egress points for the network (and thus, these NDs are sometimes referred to as edge NDs; while the other NDs may be called core NDs).

Two of the exemplary ND implementations in FIG. 10A are: 1) a special-purpose network device 1002 that uses custom application-specific integrated-circuits (ASICs) and a special-purpose operating system (OS); and 2) a general purpose network device 1004 that uses common off-the-shelf (COTS) processors and a standard OS.

The special-purpose network device 1002 includes networking hardware 1010 comprising compute resource(s) 1012 (which typically include a set of one or more processors), forwarding resource(s) 1014 (which typically include one or more ASICs and/or network processors), and physical network interfaces (NIs) 1016 (sometimes called physical ports), as well as non-transitory machine readable storage media 1018 having stored therein networking software 1020. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 1000A-H. During operation, the networking software 1020 may be executed by the networking hardware 1010 to instantiate a set of one or more networking software instance(s) 1022. Each of the networking software instance(s) 1022, and that part of the networking hardware 1010 that executes that network software instance (be it hardware dedicated to that networking software instance and/or time slices of hardware temporally shared by that networking software instance with others of the networking software instance(s) 1022), form a separate virtual network element 1030A-R. Each of the virtual network element(s) (VNEs) 1030A-R includes a control communication and configuration module 1032A-R (sometimes referred to as a local control module or control communication module) and forwarding table(s) 1034A-R, such that a given virtual network element (e.g., 1030A) includes the control communication and configuration module (e.g., 1032A), a set of one or more forwarding table(s) (e.g., 1034A), and that portion of the networking hardware 1010 that executes the virtual network element (e.g., 1030A).

The special-purpose network device 1002 is often physically and/or logically considered to include: 1) a ND control plane 1024 (sometimes referred to as a control plane) comprising the compute resource(s) 1012 that execute the control communication and configuration module(s) 1032A-R; and 2) a ND forwarding plane 1026 (sometimes referred to as a forwarding plane, a data plane, or a media plane) comprising the forwarding resource(s) 1014 that utilize the forwarding table(s) 1034A-R and the physical NIs 1016. By way of example, where the ND is a router (or is implementing routing functionality), the ND control plane 1024 (the compute resource(s) 1012 executing the control communication and configuration module(s) 1032A-R) is typically responsible for participating in controlling how data (e.g., packets) is to be routed (e.g., the next hop for the data and the outgoing physical NI for that data) and storing that routing information in the forwarding table(s) 1034A-R, and the ND forwarding plane 1026 is responsible for receiving that data on the physical NIs 1016 and forwarding that data out the appropriate ones of the physical NIs 1016 based on the forwarding table(s) 1034A-R.

FIG. 10B illustrates an exemplary way to implement the special-purpose network device 1002 according to some embodiments of the invention. FIG. 10B shows a special-purpose network device including cards 1038 (typically hot pluggable). While in some embodiments the cards 1038 are of two types (one or more that operate as the ND forwarding plane 1026 (sometimes called line cards), and one or more that operate to implement the ND control plane 1024 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1036 (e.g., a first full mesh coupling the line cards and a second full mesh coupling all of the cards).

Returning to FIG. 10A, the general purpose network device 1004 includes hardware 1040 comprising a set of one or more processor(s) 1042 (which are often COTS processors) and network interface controller(s) 1044 (NICs; also known as network interface cards) (which include physical NIs 1046), as well as non-transitory machine readable storage media 1048 having stored therein software 1050. During operation, the processor(s) 1042 execute the software 1050 to instantiate one or more sets of one or more applications 1064A-R. While one embodiment does not implement virtualization, alternative embodiments may use different forms of virtualization. For example, in one such alternative embodiment the virtualization layer 1054 represents the kernel of an operating system (or a shim executing on a base operating system) that allows for the creation of multiple instances 1062A-R called software containers that may each be used to execute one (or more) of the sets of applications 1064A-R; where the multiple software containers (also called virtualization engines, virtual private servers, or jails) are user spaces (typically a virtual memory space) that arc separate from each other and separate from the kernel space in which the operating system is run; and where the set of applications running in a given user space, unless explicitly allowed, cannot access the memory of the other processes. In another such alternative embodiment the virtualization layer 1054 represents a hypervisor (sometimes referred to as a virtual machine monitor (VMM)) or a hypervisor executing on top of a host operating system, and each of the sets of applications 1064A-R is run on top of a guest operating system within an instance 1062A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1040, directly on a hypervisor (in which case the unikernel is sometimes described as running within a LibOS virtual machine), or in a software container, embodiments can be implemented fully with unikernels running directly on a hypervisor represented by virtualization layer 1054, unikernels running within software containers represented by instances 1062A-R, or as a combination of unikernels and the above-described techniques (e.g., unikernels and virtual machines both run directly on a hypervisor, unikernels and sets of applications that are run in different software containers).

The instantiation of the one or more sets of one or more applications 1064A-R, as well as virtualization if implemented, are collectively referred to as software instance(s) 1052. Each set of applications 1064A-R, corresponding virtualization construct (e.g., instance 1062A-R) if implemented, and that part of the hardware 1040 that executes them (be it hardware dedicated to that execution and/or time slices of hardware temporally shared), forms a separate virtual network element(s) 1060A-R. In the embodiments, the application 1064A-R include a multicast mobility manager 1065A-R that implements the functions described herein above to facilitate multicast group membership and forwarding using BIER bitmaps.

The virtual network element(s) 1060A-R perform similar functionality to the virtual network element(s) 1030A-R—e.g., similar to the control communication and configuration module(s) 1032A and forwarding table(s) 1034A (this virtualization of the hardware 1040 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 1062A-R corresponding to one VNE 1060A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1062A-R to VNEs also apply to embodiments where such a finer level of granularity and/or unikernels are used.

In certain embodiments, the virtualization layer 1054 includes a virtual switch that provides similar forwarding services as a physical Ethernet switch. Specifically, this virtual switch forwards traffic between instances 1062A-R and the NIC(s) 1044, as well as optionally between the instances 1062A-R; in addition, this virtual switch may enforce network isolation between the VNEs 1060A-R that by policy are not permitted to communicate with each other (e.g., by honoring virtual local area networks (VLANs)).

The third exemplary ND implementation in FIG. 10A is a hybrid network device 1006, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1002) could provide for para-virtualization to the networking hardware present in the hybrid network device 1006.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1030A-R, VNEs 1060A-R, and those in the hybrid network device 1006) receives data on the physical NIs (e.g., 1016, 1046) and forwards that data out the appropriate ones of the physical NIs (e.g., 1016, 1046). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 10C illustrates various exemplary ways in which VNEs may be coupled according to some embodiments of the invention. FIG. 10C shows VNEs 1070A.1-1070A.P (and optionally VNEs 1070A.Q-1070A.R) implemented in ND 1000A and VNE 1070H.1 in ND 1000H. In FIG. 10C, VNEs 1070A.1-P are separate from each other in the sense that they can receive packets from outside ND 1000A and forward packets outside of ND 1000A; VNE 1070A.1 is coupled with VNE 1070H.1, and thus they communicate packets between their respective NDs; VNE 1070A.2-1070A.3 may optionally forward packets between themselves without forwarding them outside of the ND 1000A; and VNE 1070A.P may optionally be the first in a chain of VNEs that includes VNE 1070A.Q followed by VNE 1070A.R (this is sometimes referred to as dynamic service chaining, where each of the VNEs in the series of VNEs provides a different service—e.g., one or more layer 4-7 network services). While FIG. 10C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 10A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 10A may also host one or more such servers (e.g., in the case of the general purpose network device 1004, one or more of the software instances 1062A-R may operate as servers; the same would be true for the hybrid network device 1006; in the case of the special-purpose network device 1002, one or more such servers could also be run on a virtualization layer executed by the compute resource(s) 1012); in which case the servers are said to be co-located with the VNEs of that ND.

A virtual network is a logical abstraction of a physical network (such as that in FIG. 10A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 10D illustrates a network with a single network element on each of the NDs of FIG. 10A, and within this straight forward approach contrasts a traditional distributed approach (commonly used by traditional routers) with a centralized approach for maintaining reachability and forwarding information (also called network control), according to some embodiments of the invention. Specifically, FIG. 10D illustrates network elements (NEs) 1070A-H with the same connectivity as the NDs 1000A-H of FIG. 10A.

FIG. 10D illustrates that the distributed approach 1072 distributes responsibility for generating the reachability and forwarding information across the NEs 1070A-H; in other words, the process of neighbor discovery and topology discovery is distributed.

For example, where the special-purpose network device 1002 is used, the control communication and configuration module(s) 1032A-R of the ND control plane 1024 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 1070A-H (e.g., the compute resource(s) 1012 executing the control communication and configuration module(s) 1032A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 1024. The ND control plane 1024 programs the ND forwarding plane 1026 with information (e.g., adjacency and route information) based on the routing structure(s). For example, the ND control plane 1024 programs the adjacency and route information into one or more forwarding table(s) 1034A-R (e.g., Forwarding Information Base (FIB), Label Forwarding Information Base (LFIB), and one or more adjacency structures) on the ND forwarding plane 1026. For layer 2 forwarding, the ND can store one or more bridging tables that are used to forward data based on the layer 2 information in that data. While the above example uses the special-purpose network device 1002, the same distributed approach 1072 can be implemented on the general purpose network device 1004 and the hybrid network device 1006.

FIG. 10D illustrates that a centralized approach 1074 (also known as software defined networking (SDN)) that decouples the system that makes decisions about where traffic is sent from the underlying systems that forwards traffic to the selected destination. The illustrated centralized approach 1074 has the responsibility for the generation of reachability and forwarding information in a centralized control plane 1076 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 1076 has a south bound interface 1082 with a data plane 1080 (sometime referred to the infrastructure layer, network forwarding plane, or forwarding plane (which should not be confused with a ND forwarding plane)) that includes the NEs 1070A-H (sometimes referred to as switches, forwarding elements, data plane elements, or nodes). The centralized control plane 1076 includes a network controller 1078, which includes a centralized reachability and forwarding information module 1079 that determines the reachability within the network and distributes the forwarding information to the NEs 1070A-H of the data plane 1080 over the south bound interface 1082 (which may use the OpenFlow protocol). Thus, the network intelligence is centralized in the centralized control plane 1076 executing on electronic devices that are typically separate from the NDs.

For example, where the special-purpose network device 1002 is used in the data plane 1080, each of the control communication and configuration module(s) 1032A-R of the ND control plane 1024 typically include a control agent that provides the VNE side of the south bound interface 1082. In this case, the ND control plane 1024 (the compute resource(s) 1012 executing the control communication and configuration module(s) 1032A-R) performs its responsibility for participating in controlling how data (e.g., packets) is to be routed (e.g., the next hop for the data and the outgoing physical NI for that data) through the control agent communicating with the centralized control plane 1076 to receive the forwarding information (and in some cases, the reachability information) from the centralized reachability and forwarding information module 1079 (it should be understood that in some embodiments of the invention, the control communication and configuration module(s) 1032A-R, in addition to communicating with the centralized control plane 1076, may also play some role in determining reachability and/or calculating forwarding information—albeit less so than in the case of a distributed approach; such embodiments are generally considered to fall under the centralized approach 1074, but may also be considered a hybrid approach).

While the above example uses the special-purpose network device 1002, the same centralized approach 1074 can be implemented with the general purpose network device 1004 (e.g., each of the VNE 1060A-R performs its responsibility for controlling how data (e.g., packets) is to be routed (e.g., the next hop for the data and the outgoing physical NI for that data) by communicating with the centralized control plane 1076 to receive the forwarding information (and in some cases, the reachability information) from the centralized reachability and forwarding information module 1079; it should be understood that in some embodiments of the invention, the VNEs 1060A-R, in addition to communicating with the centralized control plane 1076, may also play some role in determining reachability and/or calculating forwarding information—albeit less so than in the case of a distributed approach) and the hybrid network device 1006. In fact, the use of SDN techniques can enhance the NFV techniques typically used in the general purpose network device 1004 or hybrid network device 1006 implementations as NFV is able to support SDN by providing an infrastructure upon which the SDN software can be run, and NFV and SDN both aim to make use of commodity server hardware and physical switches.

FIG. 10D also shows that the centralized control plane 1076 has a north bound interface 1084 to an application layer 1086, in which resides application(s) 1088. The centralized control plane 1076 has the ability to form virtual networks 1092 (sometimes referred to as a logical forwarding plane, network services, or overlay networks (with the NEs 1070A-H of the data plane 1080 being the underlay network)) for the application(s) 1088. Thus, the centralized control plane 1076 maintains a global view of all NDs and configured NEs/VNEs, and it maps the virtual networks to the underlying NDs efficiently (including maintaining these mappings as the physical network changes either through hardware (ND, link, or ND component) failure, addition, or removal). In the embodiments, the applications 1088 include a multicast mobility manager 1081 that implements the functions described herein above to facilitate multicast group membership and forwarding using BIER bitmaps.

While FIG. 10D shows the distributed approach 1072 separate from the centralized approach 1074, the effort of network control may be distributed differently or the two combined in certain embodiments of the invention. For example: 1) embodiments may generally use the centralized approach (SDN) 1074, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 1074, but may also be considered a hybrid approach.

While FIG. 10D illustrates the simple case where each of the NDs 1000A-H implements a single NE 1070A-H, it should be understood that the network control approaches described with reference to FIG. 10D also work for networks where one or more of the NDs 1000A-H implement multiple VNEs (e.g., VNEs 1030A-R, VNEs 1060A-R, those in the hybrid network device 1006). Alternatively, or in addition, the network controller 1078 may also emulate the implementation of multiple VNEs in a single ND. Specifically, instead of (or in addition to) implementing multiple VNEs in a single ND, the network controller 1078 may present the implementation of a VNE/NE in a single ND as multiple VNEs in the virtual networks 1092 (all in the same one of the virtual network(s) 1092, each in different ones of the virtual network(s) 1092, or some combination). For example, the network controller 1078 may cause an ND to implement a single VNE (a NE) in the underlay network, and then logically divide up the resources of that NE within the centralized control plane 1076 to present different VNEs in the virtual network(s) 1092 (where these different VNEs in the overlay networks are sharing the resources of the single VNE/NE implementation on the ND in the underlay network).

On the other hand, FIGS. 10E and 10F respectively illustrate exemplary abstractions of NEs and VNEs that the network controller 1078 may present as part of different ones of the virtual networks 1092. FIG. 10E illustrates the simple case of where each of the NDs 1000A-H implements a single NE 1070A-H (see FIG. 10D), but the centralized control plane 1076 has abstracted multiple of the NEs in different NDs (the NEs 1070A-C and G-H) into (to represent) a single NE 10701 in one of the virtual network(s) 1092 of FIG. 10D, according to some embodiments of the invention. FIG. 10E shows that in this virtual network, the NE 10701 is coupled to NE 1070D and 1070F, which are both still coupled to NE 1070E.

FIG. 10F illustrates a case where multiple VNEs (VNE 1070A.1 and VNE 1070H.1) are implemented on different NDs (ND 1000A and ND 1000H) and are coupled to each other, and where the centralized control plane 1076 has abstracted these multiple VNEs such that they appear as a single VNE 1070T within one of the virtual networks 1092 of FIG. 10D, according to some embodiments of the invention. Thus, the abstraction of a NE or VNE can span multiple NDs.

While some embodiments of the invention implement the centralized control plane 1076 as a single entity (e.g., a single instance of software running on a single electronic device), alternative embodiments may spread the functionality across multiple entities for redundancy and/or scalability purposes (e.g., multiple instances of software running on different electronic devices).

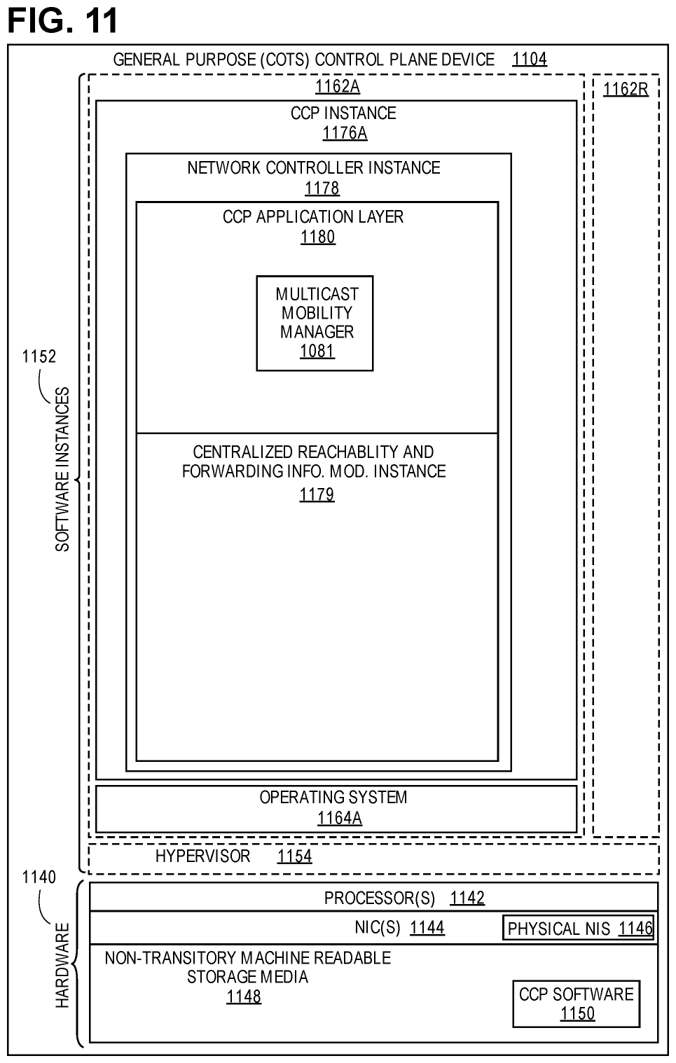

Similar to the network device implementations, the electronic device(s) running the centralized control plane 1076, and thus the network controller 1078 including the centralized reachability and forwarding information module 1079, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 11 illustrates, a general purpose control plane device 1104 including hardware 1140 comprising a set of one or more processor(s) 1142 (which are often COTS processors) and network interface controller(s) 1144 (NICs; also known as network interface cards) (which include physical NIs 1146), as well as non-transitory machine readable storage media 1148 having stored therein centralized control plane (CCP) software 1150.

In embodiments that use compute virtualization, the processor(s) 1142 typically execute software to instantiate a virtualization layer 1154 (e.g., in one embodiment the virtualization layer 1154 represents the kernel of an operating system (or a shim executing on a base operating system) that allows for the creation of multiple instances 1162A-R called software containers (representing separate user spaces and also called virtualization engines, virtual private servers, or jails) that may each be used to execute a set of one or more applications; in another embodiment the virtualization layer 1154 represents a hypervisor (sometimes referred to as a virtual machine monitor (VMM)) or a hypervisor executing on top of a host operating system, and an application is run on top of a guest operating system within an instance 1162A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1140, directly on a hypervisor represented by virtualization layer 1154 (in which case the unikernel is sometimes described as running within a LibOS virtual machine), or in a software container represented by one of instances 1162A-R). Again, in embodiments where compute virtualization is used, during operation an instance of the CCP software 1150 (illustrated as CCP instance 1176A) is executed (e.g., within the instance 1162A) on the virtualization layer 1154. In embodiments where compute virtualization is not used, the CCP instance 1176A is executed, as a unikernel or on top of a host operating system, on the “bare metal” general purpose control plane device 1104. The instantiation of the CCP instance 1176A, as well as the virtualization layer 1154 and instances 1162A-R if implemented, are collectively referred to as software instance(s) 1152.

In some embodiments, the CCP instance 1176A includes a network controller instance 1178. The network controller instance 1178 includes a centralized reachability and forwarding information module instance 1179 (which is a middleware layer providing the context of the network controller 1078 to the operating system and communicating with the various NEs), and an CCP application layer 1180 (sometimes referred to as an application layer) over the middleware layer (providing the intelligence required for various network operations such as protocols, network situational awareness, and user—interfaces). At a more abstract level, this CCP application layer 1180 within the centralized control plane 1076 works with virtual network view(s) (logical view(s) of the network) and the middleware layer provides the conversion from the virtual networks to the physical view. In the embodiments, the application layer 1180 or similar layer includes a multicast mobility manager 1181 that implements the functions described herein above to facilitate multicast group membership and forwarding using BIER bitmaps.

The centralized control plane 1076 transmits relevant messages to the data plane 1080 based on CCP application layer 1180 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 1080 may receive different messages, and thus different forwarding information. The data plane 1080 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 1080, the packet (or a subset of the packet header and content) is typically forwarded to the centralized control plane 1076. The centralized control plane 1076 will then program forwarding table entries into the data plane 1080 to accommodate packets belonging to the flow of the unknown packet. Once a specific forwarding table entry has been programmed into the data plane 1080 by the centralized control plane 1076, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method implemented by a network device functioning as an ingress tunnel router to facilitate multicast traffic forwarding and mobility in a network with mobile devices, the method comprising:
receiving data traffic to broadcast to a multicast group;
querying a locator identifier separation protocol (LISP) mapping system to get a list of routing locators (RLOCS) for members of the multicast group;
constructing a bit indexed explicit replication (BIER) bitmap of the RLOCs; and
forwarding data traffic for the multicast group using the BIER bitmap.

2. The method of claim 1, further comprising:
registering as a source for the multicast group with the LISP mapping system.

3. A method implemented by a network device functioning as an egress tunnel router to facilitate multicast traffic forwarding and mobility in a network with mobile devices, the method comprising:
receiving a join for a multicast group from a subscriber node;
registering interest in the multicast group with a locator identifier separation protocol (LISP) mapping system;
receiving data traffic using a bit indexed explicit replication (BIER) bitmap identifying the egress tunnel router; and
forwarding the data traffic to the subscriber node.

4. The method of claim 3, wherein the network device is also a source tunnel router, the method further comprising:
receiving a handover request; and
sending a handover message to a target tunnel router.

5. The method of claim 4, further comprising:
proxying multicast traffic to the target tunnel router where the target tunnel router is determined not to be a member of the multicast group.

6. The method of claim 4, further comprising:
receiving a multicast control message from a multicast ingress tunnel router indicating that a target tunnel router is a member of the multicast group; and
ending proxying of multicast traffic to the target tunnel router in response to the multicast control message.

7. The method of claim 3, wherein the network device is also a target tunnel router, the method further comprising:
receiving a handover message from a source tunnel router including an endpoint identifier (EID);
receiving a notification of the endpoint identifier (EID) availability; and
receiving multicast traffic for the multicast group for the EID.

8. A network device functioning as an ingress tunnel router to execute a method to facilitate multicast traffic forwarding and mobility in a network with mobile devices, the network device comprising:
a non-transitory computer readable medium having stored therein a multicast mobility manager; and
a processor coupled to the non-transitory computer readable medium, the processor to execute the multicast mobility manager, the multicast mobility manager to receive data traffic to broadcast to a multicast group, to query a locator identifier separation protocol (LISP) mapping system to get a list of routing locators (RLOCS) for members of the multicast group, to construct a bit indexed explicit replication (BIER) bitmap of the RLOCs, and to forward data traffic for the multicast group using the BIER bitmap.

9. The network device of claim 8, wherein the multicast mobility manager to register as a source for the multicast group with the LISP mapping system.

10. A network device functioning as an egress tunnel router to execute a method to facilitate multicast traffic forwarding and mobility in a network with mobile devices, the network device comprising:
a non-transitory computer readable medium having stored therein a multicast mobility manager; and
a processor coupled to the non-transitory computer readable medium, the processor to execute the multicast mobility manager, the multicast mobility manager to receive a join for a multicast group from a subscriber node, to register interest in the multicast group with a locator identifier separation protocol (LISP) mapping system, to receive data traffic using a bit indexed explicit replication (BIER) bitmap identifying the egress tunnel router, and to forward the data traffic to the subscriber node.

11. The network device of claim 10, wherein the network device is also a source tunnel router, the multicast mobility manager further to receive a handover request, and to send a handover message to a target tunnel router.

12. The network device of claim 11, wherein the multicast mobility manager is further to proxy multicast traffic to the target tunnel router where the target tunnel router is determined not to be a member of the multicast group.

13. The network device of claim 11, wherein the multicast mobility manager is further to receive a multicast control message from a multicast ingress tunnel router indicating that a target tunnel router is a member of the multicast group, and to end proxying of multicast traffic to the target tunnel router in response to the multicast control message.

14. The network device of claim 10, wherein the network device is also a target tunnel router, the multicast mobility manager to receive a handover message from a source tunnel router including an endpoint identifier (EID), to receive a notification of the endpoint identifier (EID) availability, and to receive multicast traffic for the multicast group for the EID.
